(19) United States
(12) Patent Application Publication
(10) Pub. No.: US 2026/0153143 A1
(43) Pub. Date: Jun. 4, 2026

(54) TRANSMISSION WITH AN OIL SUPPLY BETWEEN TRANSMISSION AREAS, AND METHOD FOR OPERATING THE TRANSMISSION

(71) Applicant: Schaeffler Technologies AG & Co. KG, Herzogenaurach (DE)

(72) Inventors: Marc HELFER, Ottrott (FR); Felix VOGEL, Sinzheim (DE)

(73) Assignee: Schaeffler Technologies AG & Co. KG, Herzogenaurach (DE)

(21) Appl. No.: 18/717,113

(22) PCT Filed: Nov. 8, 2022
(86) PCT No.: PCT/DE2022/100825

§ 371 Date: Jun. 6, 2024

(30) Foreign Application Priority Data
Dec. 7, 2021 (DE) 10 2021 132 150.6

(51) Int. Cl. F16H 57/04

(52) U.S. Cl. CPC F16H 57/0453; F16H 57/0409; F16H 57/0436; F16H 57/0457; F16H 57/0476; F16H 57/0483

(57) ABSTRACT

A a transmission for the powertrain of a motor vehicle, including a housing and a differential unit which is arranged in a receiving area of the housing. An oil collecting chamber is additionally arranged on a lower face of the housing when viewed with respect to a planned installation position in a gravitational field, and the oil collecting chamber is spatially separated from the receiving chamber by an intermediate wall and is directly connected to the receiving chamber by a connecting channel which is introduced into the intermediate wall. A method for operating the transmission is also provided.

### CROSS-REFERENCE TO RELATED APPLICATIONS

This application is the U.S. National Phase of PCT Appln. No. PCT/DE2022/100825, filed Nov. 8, 2022, which claims priority from German Patent Application No. 10 2021 132 150.6, filed Dec. 7, 2021, the entire disclosures of which are incorporated by reference herein.

### TECHNICAL FIELD

The disclosure relates to a transmission for a powertrain of a motor vehicle, comprising a housing and a differential unit which is arranged in a receiving area (first transmission area) of the housing, wherein an oil collecting chamber is additionally arranged on a lower face of the housing, when viewed with respect to a planned installation position (of the transmission) in the gravitational field. Furthermore, the disclosure relates to a method for operating said transmission.

### BACKGROUND

Transmissions of the type in question are already sufficiently known in the prior art. In this regard, EP 3 534 042 A1, for example, discloses a powertrain of a motor vehicle with a transmission. A collecting container is provided in a housing of the transmission, which stores lubricating oil. A supply path is further provided in this housing for introducing the lubricating oil, which is introduced through a differential transmission mechanism during reverse travel of the motor vehicle. An outlet passage connected to an outlet port of an oil pump is further also connected to the collecting container.

In previous transmission designs, it has been found that existing transmission losses arise in particular from the drag torques generated when the transmission components, such as the differential unit, move/rotate due to an oil sump in the transmission. At the same time, the individual components of the transmission, such as gear wheels, bearings and shafts, should be sufficiently lubricated/cooled.

### SUMMARY

It is therefore the object of the present disclosure to provide a transmission whose efficiency losses caused during operation by coolant and/or lubricant delivery are reduced, while at the same time ensuring a sufficient oil supply for longevity of the transmission.

This is achieved according to the disclosure in that the oil collecting chamber is spatially separated from the receiving area by an intermediate wall and is (hydraulically) connected directly to the receiving area by means of a connecting channel which is introduced in the intermediate wall.

This makes it possible to maintain a higher oil level during operation in the oil collecting chamber (second transmission area) of the transmission housing directly adjacent to the receiving area of the differential unit than in the receiving area itself, in order to keep sufficient oil in the oil collecting chamber for storage, while at the same time allowing the differential unit to run within the receiving area at the lowest possible oil level in order to avoid drag losses. This increases the efficiency of the transmission.

Further advantageous embodiments are claimed in the claims and explained in more detail below.

In this regard, it is also advantageous if the oil collecting chamber, in particular on the part of its intermediate wall, is formed by a plastic component inserted into the housing. This plastic component is firmly attached to the housing, for example in a form-fitting and/or force-fitting manner. This significantly reduces the manufacturing effort required to produce the intermediate wall.

If the oil collecting chamber is arranged at least in sections below the receiving area (again viewed in respect to the gravitational field), reliable functioning of the transmission is made possible.

Furthermore, it is advantageous if the receiving area forms/has a circumferential oil collecting trough on its radial outer side, within which oil collecting trough an outer toothing of an input gear of the differential unit is arranged. This ensures that the input gear of the differential directly forms the component that simultaneously distributes the oil in the receiving area and transports it further. This ensures functionality.

In addition, it is advantageous if the connecting channel is arranged radially at the level of the oil collecting rail, more preferably radially at the level of a widening area of the input gear having the outer toothing. As a result, the oil entering the receiving area from the oil collecting chamber during operation can directly reach the areas of the input gear used to further convey the oil. This makes it possible to further reduce drag losses.

It is also advantageous if an intermediate gear wheel associated with the differential unit and/or operatively connected to the differential unit is arranged in the receiving area and an opening is present in the housing or a component forming the intermediate wall, which opening connects the oil collecting chamber to the receiving area in the region of the intermediate gear wheel.

For the most efficient way of working, it is also useful if a radial gap between an inner side of the housing/receiving area and the outer toothing has a height of between 1 mm and 5 mm. This further reduces the amount of oil required during operation.

Furthermore, it is advantageous if a pump is integrated in the oil collecting chamber and/or a suction side of the pump is connected to the oil collecting chamber. The pump is particularly preferably a non-reversible pump. This further simplifies the manufacturing effort.

The efficiency of the drive is further increased if the pump is connected to a cooling circuit flowing through an electrical machine.

It is also advantageous if a further transmission area, which accommodates at least one further transmission unit is provided adjacent to the receiving area, which further transmission area is at least hydraulically connected to the oil collecting chamber. This means that other transmission components are efficiently supplied with the same oil during operation.

If the transmission area is formed directly by the oil collecting chamber or, conversely, the oil collecting chamber is formed directly by the transmission area, the manufacturing costs of the transmission are further reduced.

The disclosure further relates to a method for operating a transmission according to the disclosure according to at least one of the previously described embodiments, wherein an oil level built up in the oil collecting chamber is maintained above the connecting channel when the differential unit is rotating.

In other words, according to the disclosure, an oil supply is implemented between two separately provided transmission areas (receiving area and oil collecting chamber). There is an opening (connecting channel) between the two transmission areas for optimal lubrication in the separate transmission areas.

### BRIEF DESCRIPTION OF THE DRAWINGS

The disclosure will now be explained in more detail below with reference to figures.

In the figures:

FIG. 1 shows a sectional view of a transmission according to the disclosure implemented according to a preferred exemplary embodiment, wherein a differential unit of the transmission is shown cut in the longitudinal direction and a hydraulic connection of a receiving area accommodating the differential unit to an oil collecting chamber by means of a connecting channel can be clearly seen,

FIG. 2 shows a detailed view of FIG. 1 in the area of the connecting channel,

FIG. 3 shows a perspective view of the transmission of FIG. 1 from an outer side, wherein the transmission is shown partially cut, so that an intermediate wall spatially separating the oil collecting chamber relative to the receiving area can be seen, and

FIG. 4 shows a further sectional view of the partially shown transmission according to FIG. 1, wherein the sectional plane is now selected such that, in addition to the differential unit, further transmission components can be seen.

### DETAILED DESCRIPTION

The figures are merely schematic in nature and serve solely for understand-ing the disclosure. Identical elements are provided with the same reference symbols.

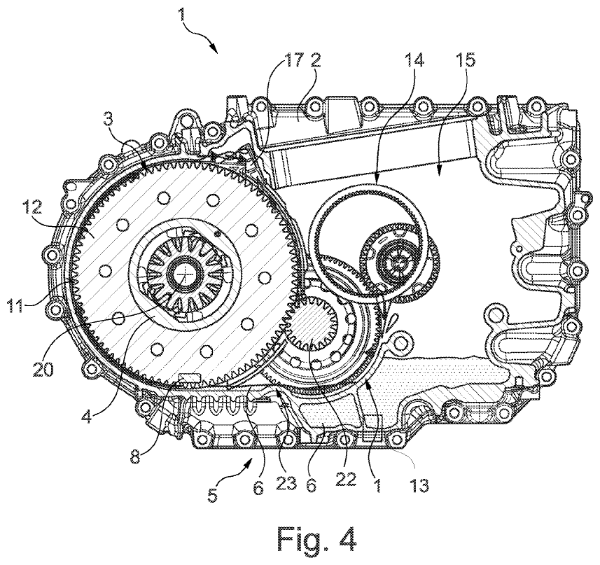

FIG. 4 initially shows a transmission 1 according to the disclosure in its en-tirety according to a preferred exemplary embodiment. The transmission 1 has a differential unit 4. The differential unit 4 is coupled in the usual way on the input side with further transmission components, which are generally identified here as further transmission unit 14, and is further connected on the output side to the wheels of the motor vehicle.

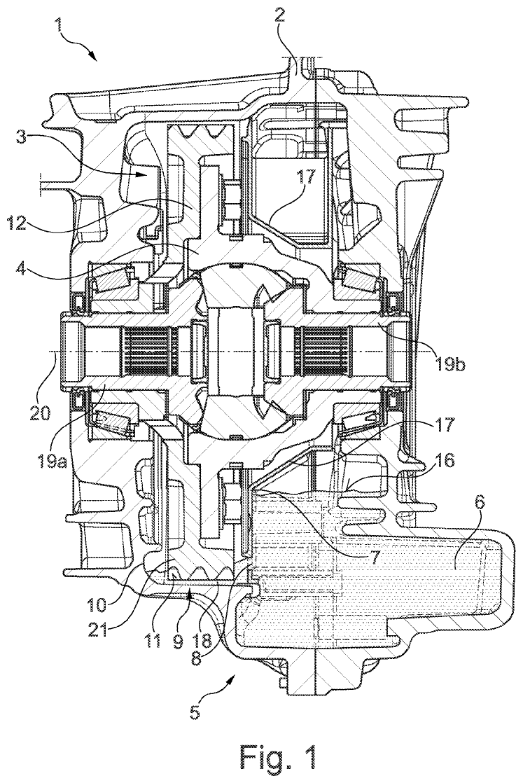

The differential unit 4 has an input gear 12 which forms the input. In FIG. 1, the respective output shaft 19a, 19b (output) of the differential unit 4, which is further connected to a wheel of the motor vehicle, can also be seen particularly well.

In addition to the differential unit 4, the transmission 1 has further gear stages comprising the further transmission unit 14. The transmission 1 is preferably designed as a multi-speed transmission/manual transmission and can therefore be coupled to the input gear 12 via several different gear ratios.

In this context, it should also be noted in principle that the transmission 1 is further preferably designed as a hybrid transmission and therefore, in a particularly preferred embodiment, has an electrical machine, not shown here for the sake of clarity, for driving the motor vehicle. The electrical machine is then preferably also inserted into the housing 2 of the transmission 1. An output/rotor of the electrical machine is then preferably connected to the differential unit 4 by means of the transmission unit 14.

Furthermore, it can be seen that the transmission area 15 accommodating the transmission unit 14 forms an oil collecting chamber 6. This oil collecting chamber 6 is designed to form a lower face 5 of the housing 2 when viewed with respect to the intended installation position of the transmission 1 in the gravitational field. The oil collecting chamber 6, also known as an oil sump, serves to collect and temporarily store a certain amount of oil during operation and is therefore provided at the lowest point of the housing 2.

It should be noted that a pump 13, which is only indicated schematically here, is preferably also inserted in the housing 2, in particular in the oil collecting chamber 6, or is at least connected to this oil collecting chamber 6 by its suction line, which is not shown for the sake of clarity. This pump 13 then serves to generate its own cooling circuit, which flows through the electrical machine. A certain oil level 16 must therefore be maintained in the oil collecting chamber 6 for lubrication and cooling of the corresponding components of the transmission 1.

Finally, as can be seen in detail in connection with FIGS. 1 to 3, the differential unit 4 is accommodated in a receiving area 3, which is spatially separated from the oil collecting chamber 6 and thus also from the transmission area 15. The receiving area 3 therefore also forms a (first) transmission area, which is separated from the (second) transmission area 15 accommodating the transmission unit 14.

The differential unit 4 is connected to the transmission unit 14 via an intermediate gear wheel 22 which is assigned to the differential unit 4 and is in direct meshing engagement with the input gear 12. The intermediate gear wheel 22 is still arranged (at least partially) in the receiving area. It is also indicated in connection with FIG. 4, that an opening 23 is present in the housing 2 or the plastic component/component 17 forming the intermediate wall 7, which opening 23 connects the oil collecting chamber 6 with the receiving area 3 in the area of the intermediate gear wheel 22.

An intermediate wall 7 is inserted axially between the receiving area 3 and the oil collecting chamber 6. This intermediate wall 7 is formed directly by a trough-shaped/arch-shaped, partially circumferential plastic component 17. As shown in FIG. 4, this plastic component 17 is also connected to the transmission area 15 and thus also ensures the supply of oil to the transmission area 15.

The receiving area 3 is connected to the oil collecting chamber 6 through a connecting channel 8 which is introduced into the intermediate wall 7 to the lower face 5 of the housing 2. This connecting channel 8 is dimensioned in such a way that it supplies an amount of oil to the receiving area 3 during operation of the transmission 1 with the differential unit 4 rotating, which at the same time corresponds to a discharge amount/amount transported away by the input gear 12.

With regard to the position of the connecting channel 8, it can also be seen that, viewed with respect to an axis of rotation 20 of the differential unit 4, it is arranged at a radial height (the radial direction is perpendicular to the axis of rotation 20) with the outer toothing 11 of the input gear 12. In particular, the connecting channel 8 is arranged at the radial height of a thickening area 21 of the input gear 12, which in turn directly forms the outer toothing 11. This thickening area 21 is further arranged in a widened oil collecting trough 10 of the receiving area 3. The oil collecting trough 10 directly forms the radial outer side 9 of the receiving area 3. A radial gap 18 between the outer side of the outer toothing 11 and the inner side of the housing 2 is preferably approximately 1 mm thick/high (radial dimension) in this area.

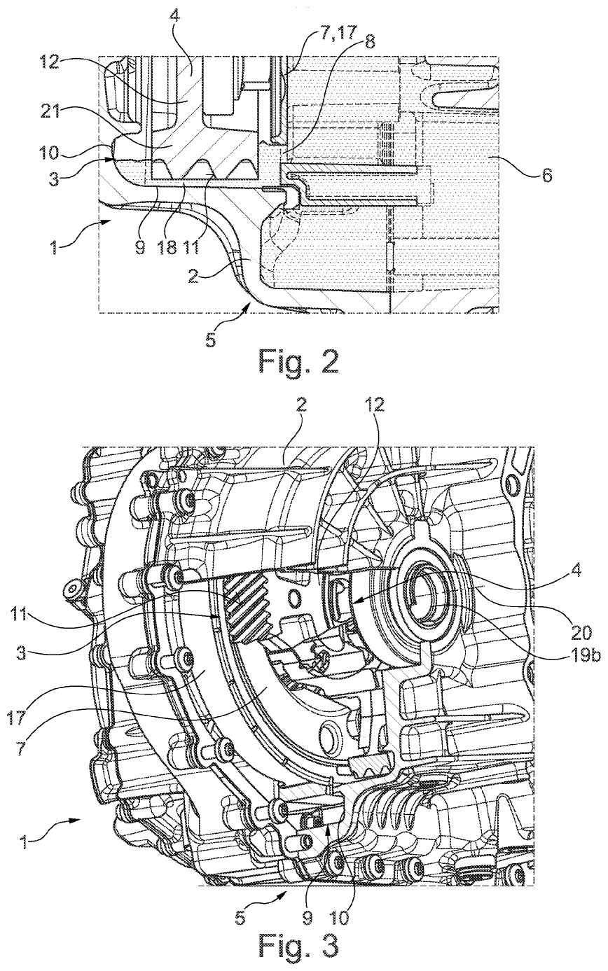

FIG. 1, FIG. 2 and FIG. 4 also show how the oil collecting chamber 6 is usually filled with oil during operation. It can be seen here that, according to a preferred method for operating the transmission 1, the corresponding feed devices, which are not shown here for the sake of clarity, and the pump 13 are operated in such a way that an oil level 16 within the oil collecting chamber 6 is/is maintained higher/above the connecting channel 8. This ensures that sufficient oil supply can take place in the receiving area 3 even when cornering.

In other words, the interception mechanism according to the disclosure is based on oil delivery within the transmission area of a transmission 1, which may be formed as a standard transmission or a hybrid transmission. The basic principle proposed here is a lubrication system in which the oil is thrown over the differential gear (input gear 12). The oil is then collected in one or more containers and from there distributed through the gearbox 1 to enable lubrication of the bearings, gears and shafts. There is an oil pump (pump 13) in transmission 1 for cooling the electrical machine(s). The pump 13 sucks the oil into the sump through an oil filter, at the lowest point of the transmission 1.

The differential gear is immersed in a trough (oil collecting trough 10), which is separated from the transmission sump (oil collecting chamber 6) via a partition (inter-mediate wall 7). Two different oil levels can be created using the transmission sump. A higher oil level in the pump suction area (in oil collecting chamber 6) guarantees that the intake is always immersed in oil, i.e. even when accelerating around curves. A second space (receiving area 3) in the area of the differential gear is filled with a limited oil level. This means that only the oil required to lubricate the gears and bearings is transported upwards. The result is a lubrication system with limited splash losses, reduced drag torque and increased efficiency.

According to the disclosure, a special oil delivery mechanism is therefore provided between transmission areas (receiving area 3 and oil collecting chamber 6/transmission area 15). The oil collecting chamber 6 requires a higher oil level to ensure the suction capacity of the cooling circuit pump (pump 13) when accelerating around cor-ners/during braking.

The differential gear is located in the other area (receiving area 3). The differential requires constant oil supply to ensure lubrication function correctly. There is a calibrated opening (connecting channel 8) between the two gearbox rooms (receiving area 3 and oil collecting chamber 6), which acts as a communication channel between the two transmission areas. The opening is designed and dimensioned so that all lubrication points of the transmission 1 receive the exactly required amount of oil through the pump action of the differential (differential unit 4). The total amount of oil required for all bearing lubrication points and gear contacts is achieved through this calibrated opening and the resulting coordinated oil delivery (via the input gear 12). This means that only the required amount of oil is used for lubrication and splash losses are minimized.

### LIST OF REFERENCE SIGNS

1 Transmission
2 Housing
3 Receiving area
4 Differential unit
5 Lower face
6 Oil collecting chamber
7 Intermediate wall
8 Connecting channel
9 Outer side
10 Oil collecting trough
11 Outer toothing
12 Input gear
13 Pump
14 Transmission unit
15 Transmission area
16 Oil level
17 Plastic component
18 Radial gap
19a First output shaft
19b Second output shaft
20 Axis of rotation
21 Thickening area
22 Intermediate gear wheel
23 Opening

1. A transmission for a powertrain of a motor vehicle, the transmission comprising:
a housing;
a differential unit arranged in a receiving area of the housing;
an oil collecting chamber arranged on a lower face of the housing, when viewed with respect to a planned installation position in a gravitational field; and
an intermediate wall that separates the oil collecting chamber from the receiving area and the oil collecting chamber is directly connected to the receiving area by a connecting channel in the intermediate wall.

2. The transmission according to claim 1, wherein the oil collecting chamber is arranged at least in sections below the receiving area.

3. The transmission according to claim 1, wherein the receiving area has a circumferential oil collecting trough on a radial outer side thereof, and an outer toothing of an input gear of the differential unit is arranged within the oil collecting trough.

4. The transmission according to claim 3, wherein the connecting channel is arranged radially at a level of the oil collecting trough.

5. The transmission according to claim 1, wherein an intermediate gear wheel associated with the differential unit and/or operatively connected to the differential unit is at least partially arranged in the receiving area and an opening is present in the housing or a component forming the intermediate wall, and the opening connects the oil collecting chamber to the receiving area in a region of the intermediate gear wheel.

6. The transmission according to claim 1, further comprising at least one of a pump integrated in the oil collecting chamber or a suction side of the pump connected to the oil collecting chamber.

7. The transmission according to claim 6, wherein the pump is connected to a cooling circuit flowing through an electrical machine.

8. The transmission according to claim 1, further comprising a further transmission area, which accommodates at least one further transmission unit, adjacent to the receiving area, the further transmission area is at least hydraulically connected to the oil collecting chamber.

9. The transmission according to claim 8, wherein the further transmission area directly forms the oil collecting chamber.

10. A method for operating a transmission, the method comprising:
providing the transmission including a housing, a differential unit arranged in a receiving area of the housing, an oil collecting chamber arranged on a lower face of the housing, when viewed with respect to a planned installation position in a gravitational field, and an intermediate wall that separates the oil collecting chamber from the receiving area, with the oil collecting chamber being directly connected to the receiving area by a connecting channel in the intermediate wall; and
maintaining an oil level built up in the oil collecting chamber above the connecting channel during rotating of the differential unit.

11. A transmission for a powertrain of a motor vehicle, the transmission comprising:
a housing;
a differential unit arranged in a receiving area of the housing;
an oil collecting chamber arranged on a lower face of the housing, when viewed with respect to a planned installation position in a gravitational field;
an intermediate wall that separates the oil collecting chamber from the receiving area and the oil collecting chamber is directly connected to the receiving area by a connecting channel in the intermediate wall; and
the oil collecting chamber has a bottom wall that is lower in the planned installation position than a circumferential oil collecting trough of the receiving area.

12. The transmission according to claim 11, wherein the oil collecting chamber is arranged at least in sections below the receiving area.

13. The transmission according to claim 11, wherein the circumferential oil collecting trough is on a radial outer side of the receiving area, and an outer toothing of an input gear of the differential unit is arranged within the oil collecting trough.

14. The transmission according to claim 13, wherein the connecting channel is arranged radially at a level of the oil collecting trough.

15. The transmission according to claim 11, wherein an intermediate gear wheel associated with the differential unit and/or operatively connected to the differential unit is at least partially arranged in the receiving area and an opening is present in the housing or a component forming the intermediate wall, and the opening connects the oil collecting chamber to the receiving area in a region of the intermediate gear wheel.

16. The transmission according to claim 11, further comprising at least one of a pump integrated in the oil collecting chamber or a suction side of the pump connected to the oil collecting chamber.

17. The transmission according to claim 16, wherein the pump is connected to a cooling circuit flowing through an electrical machine.

18. The transmission according to claim 11, further comprising a further transmission area, which accommodates at least one further transmission unit, adjacent to the receiving area, the further transmission area is at least hydraulically connected to the oil collecting chamber.

19. The transmission according to claim 18, wherein the further transmission area directly forms the oil collecting chamber.
